(19) United States
(12) Patent Application Publication
(10) Pub. No.: US 2026/0245499 A1
(43) Pub. Date: Aug. 20, 2026

(54) DISPLAY DEVICE AND ELECTRONIC DEVICE INCLUDING THE SAME

(71) Applicant: Samsung Display Co., Ltd., Yongin-si (KR)

(72) Inventors: Yuna KIM, Yongin-si (KR); Sang Min JEON, Yongin-si (KR); Hyundae LEE, Yongin-si (KR)

(73) Assignee: Samsung Display Co., Ltd., Yongin-si (KR)

(21) Appl. No.: 19/368,390

(22) Filed: Oct. 24, 2025

(30) Foreign Application Priority Data
Feb. 18, 2025 (KR) 10-2025-0020502

(51) Int. Cl. G09G 3/32; G09G 3/20

(52) U.S. Cl. CPC G09G 3/32; G09G 3/2007; G09G 2300/0819; G09G 2300/0852; G09G 2300/0861; G09G 2310/08; G09G 2320/0247; G09G 2330/021

(57) ABSTRACT

A display device may include a display panel and a display panel driver configured to driver the display panel. A pixel circuit included in the display panel may include a writing transistor, a driving transistor configured to generate a driving current based on a high power voltage and a light emitting element configured to receive the driving current. A frame period in which the pixel circuit is driven may include an emitting period in which the light emitting element emits a light and a non-emitting period in which the light emitting element does not emit a light. A first high power voltage applied to a first display region may be different from a second high power voltage applied to a second display region. A voltage level of at least one of the first high power voltage or the second high power voltage may be changed in the non-emitting period.

### CROSS-REFERENCE TO RELATED APPLICATION(S)

This application is based on and claims priority under 35 USC § 119 to Korean Patent Application No. 10-2025-0020502, filed on February 18 2025, the disclosure of which is herein incorporated by reference in its entirety.

### BACKGROUND

### Field

One or more embodiments of the present disclosure relate to a display device and an electronic device including the same. More particularly, one or more embodiments of the present disclosure relate to a display device in which a driving voltage is adjustable and an electronic device including the same.

### Description of the Related Art

Generally, a display device includes a display panel and a display panel driver. The display panel may include a plurality of gate lines, a plurality of data lines, a plurality of emission lines, and a plurality of pixels. The display panel driver includes a gate driver configured to provide a gate signal to the gate lines, a data driver configured to provide a data voltage to the plurality of data lines, an emission driver configured to provide an emission signal to the plurality of emission lines, and a driving controller configured to control the gate driver, the data driver, and the emission driver.

Generally, a driving voltage applied to a display panel may be adjusted to reduce a power consumption of a display device.

### SUMMARY

One or more embodiments of the present disclosure provide a display device in which a power consumption may be reduced, and a display quality may be improved.

One or more embodiments of the present disclosure provide an electronic device including the display device.

According to an aspect of an example embodiment, provided is a display device including: a display panel including a plurality of pixel circuits; and a display panel driver configured to driver the display panel. The display panel may include a first display region and a second display region. A pixel circuit of the plurality of pixel circuits may include a writing transistor configured to apply a data voltage in response to a write gate signal; a driving transistor configured to generate a driving current based on a high power voltage and the data voltage; and a light emitting element including a first electrode configured to receive the driving current and a second electrode configured to receive a low power voltage lower than the high power voltage. A frame period in which the pixel circuit is driven may include an emitting period in which the light emitting element emits a light and a non-emitting period in which the light emitting element does not emit a light. A first high power voltage applied to the first display region may be different from a second high power voltage applied to the second display region. A voltage level of at least one of the first high power voltage or the second high power voltage may be changed in the non-emitting period.

According to an aspect of an example embodiment, provided is a display device including: a display panel including a plurality of pixel circuits; and a display panel driver configured to driver the display panel. The display panel may include a first display region and a second display region. A pixel circuit of the plurality of pixel circuits may include a writing transistor configured to apply a data voltage in response to a write gate signal; a driving transistor configured to generate a driving current based on a high power voltage and the data voltage; and a light emitting element including a first electrode configured to receive the driving current and a second electrode configured to receive a low power voltage lower than the high power voltage. A first high power voltage applied to the first display region may be changed in a period in which the light emitting element in the first display region does not emit a light.

According to an aspect of an example embodiment, provided is an electronic device including: a display panel including a plurality of pixel circuits; a processor configured to output an input image data and an input control signal; and a display panel driver configured to drive the display panel based on the input image data and the input control signal. The display panel may include a first display region and a second display region. A pixel circuit of the plurality of pixel circuits may include: a writing transistor configured to apply a data voltage in response to a write gate signal; a driving transistor configured to generate a driving current based on a high power voltage and the data voltage; and a light emitting element including a first electrode configured to receive the driving current and a second electrode configured to receive a low power voltage lower than the high power voltage. A frame period in which the pixel circuit is driven may include an emitting period in which the light emitting element emits a light and a non-emitting period in which the light emitting element does not emit a light. A first high power voltage applied to the first display region may be different from a second high power voltage applied to the second display region. A voltage level of at least one of the first high power voltage or the second high power voltage may be changed in the non-emitting period.

### BRIEF DESCRIPTION OF DRAWINGS

Illustrative, non-limiting example embodiments will be more clearly understood from the following detailed description in conjunction with the accompanying drawings.

FIG. 1 is a block diagram illustrating a display device according to one or more embodiments of the present disclosure.

FIG. 2 is a block diagram illustrating an example of a high power voltage applied to a display panel included in the display device of FIG. 1.

FIG. 3 is a table illustrating a determined grayscale and a high power voltage level corresponding to the determined grayscale of the display panel of FIG. 1.

FIG. 4 is a block diagram illustrating an example of signals applied to a pixel circuit included in the display device of FIG. 1.

FIG. 5 is a circuit diagram illustrating an example of a pixel circuit included in the display device of FIG. 1.

FIG. 6 is a conceptual diagram illustrating a frame period of a display panel included in the display device of FIG. 1.

FIG. 7 is a timing diagram illustrating an example of a write period and an emitting period of FIG. 6.

FIG. 8 is a timing diagram illustrating signals applied to a pixel circuit of the pixel circuits included in a K-th display region included in the display panel of FIG. 2.

FIG. 9 is a timing diagram illustrating signals applied to the K-th display region included in the display panel of FIG. 2.

FIG. 10 is a timing diagram illustrating signals applied to a pixel circuit of the pixel circuits included in the K-th display region included in the display panel of FIG. 2.

FIG. 11 is a timing diagram illustrating signals applied to a pixel circuit of the pixel circuits included in the K-th display region included in the display panel of FIG. 2.

FIG. 12 is a timing diagram illustrating signals applied to a pixel circuit of the pixel circuits included in the K-th display region included in the display panel of FIG. 2.

FIG. 13 is a circuit diagram illustrating an example of a pixel circuit included in the display device of FIG. 1.

FIG. 14 is a timing diagram illustrating an example of signals applied to the pixel circuit of FIG. 13.

FIG. 15 is a circuit diagram illustrating an example of a pixel circuit included in the display device of FIG. 1.

FIG. 16 is a timing diagram illustrating an example of signals applied to the pixel circuit of FIG. 15.

FIG. 17 is a block diagram illustrating an example of the K-th display region and high power voltage lines included in the display panel of FIG. 2.

FIG. 18 is a block diagram illustrating an example of the K-th display region and high power voltage lines included in the display panel of FIG. 2.

FIG. 19 is a graph illustrating changes in a luminance waveform according to changes in a high power voltage in a display device according to a comparative example.

FIG. 20 is a graph illustrating changes in a luminance waveform according to changes in a high power voltage in the display device of FIG. 1.

FIG. 21 is a block diagram illustrating an example of a high power voltage applied to a display panel included in the display device of FIG. 1.

FIG. 22 is a block diagram illustrating a display device according to one or more embodiments of the present disclosure.

FIG. 23 is a block diagram illustrating an electronic device according to one or more embodiments of the present disclosure.

FIGS. 24 to FIG. 26 are schematic diagrams illustrating an electronic device according to one or more embodiments.

### DETAILED DESCRIPTION

Hereinafter, the present disclosure will be explained in detail with reference to the accompanying drawings.

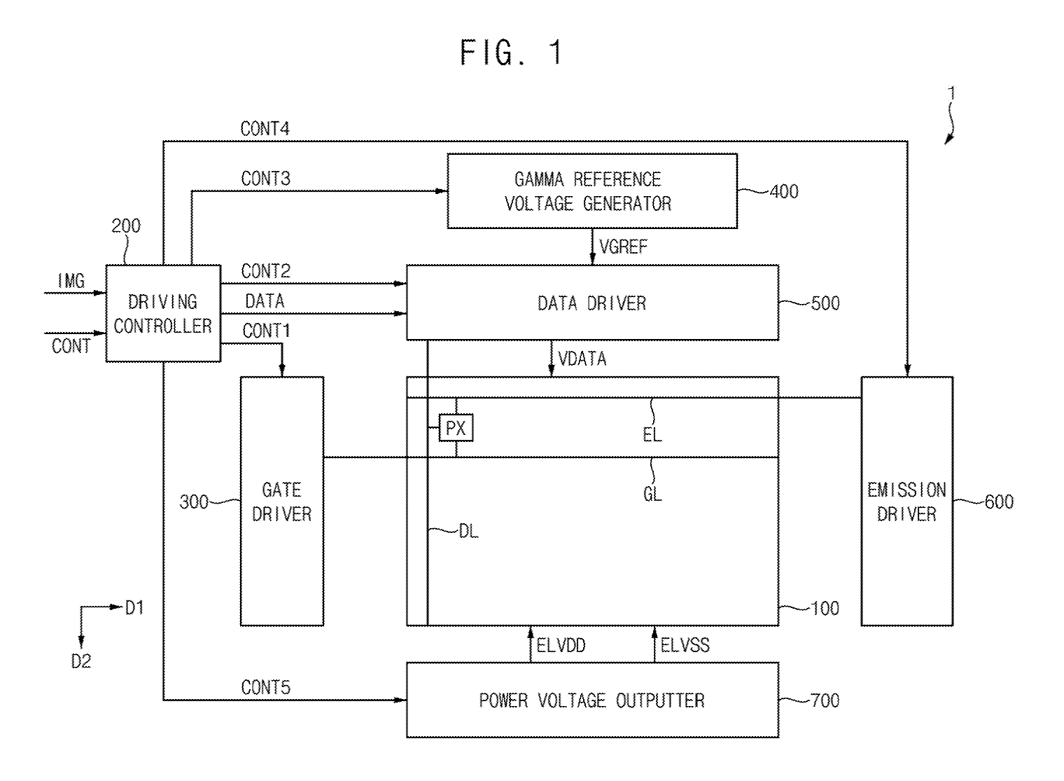

FIG. 1 is a block diagram illustrating a display device 1 according to one or more embodiments of the present disclosure.

Referring to FIG. 1, the display device 1 according to one or more embodiments may include a display panel 100 and a display panel driver. The display panel driver may include a driving controller 200, a gate driver 300, a gamma reference voltage generator 400, a data driver 500, an emission driver 600, and a power voltage outputter 700.

The display panel 100 may include a display region on which an image is displayed and a peripheral region adjacent to the display region.

The display panel 100 may include a plurality of gate lines GL, a plurality of emission lines EL, a plurality of data lines DL, and a plurality of pixel circuit PX electrically connected to the plurality of gate lines GL, the plurality of emission lines EL, and the plurality of data lines DL. The plurality of gate lines GL may extend in a first direction D1, the plurality of emission lines EL may extend in the first direction D1 and the plurality of data lines DL may extend in a second direction D2 crossing the first direction D1.

The driving controller 200 may receive input image data IMG and an input control signal CONT from an external apparatus. In an embodiment, for example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5, and a data signal DATA based on the input image data IMG and the input control signal CONT.

The driving controller 200 may generate the first control signal CONT1 for controlling an operation of the gate driver 300, based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500, based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400, based on the input control signal CONT, and output the third control signal CONT3 to the gamma reference voltage generator 400.

The driving controller 200 may generate the fourth control signal CONT4 for controlling an operation of the emission driver 600, based on the input control signal CONT, and output the fourth control signal CONT4 to the emission driver 600.

The driving controller 200 may generate the fifth control signal CONT5 for controlling an operation of the power voltage outputter 700, based on the input control signal CONT, and output the fifth control signal CONT5 to the power voltage outputter 700.

The gate driver 300 may generate gate signals for driving the plurality of gate lines GL in response to the first control signal CONT1 received from the driving controller 200. The gate driver 300 may output the gate signals to the plurality of gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the plurality of data lines DL.

In an embodiment, the data driver 500 may be disposed in the peripheral region. In an embodiment, the data driver 500 may be integrated in the peripheral region.

The emission driver 600 may generate an emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of illustration and description, the disclosure is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other in a single chip.

The power voltage outputter 700 may output a high power voltage ELVDD and a low power voltage ELVSS in response to the fifth control signal CONT5 received from the driving controller 200. The low power voltage ELVSS may be lower than the high power voltage ELVDD. The power voltage outputter 700 may output the high power voltage ELVDD and the low power voltage ELVSS to the display panel 100.

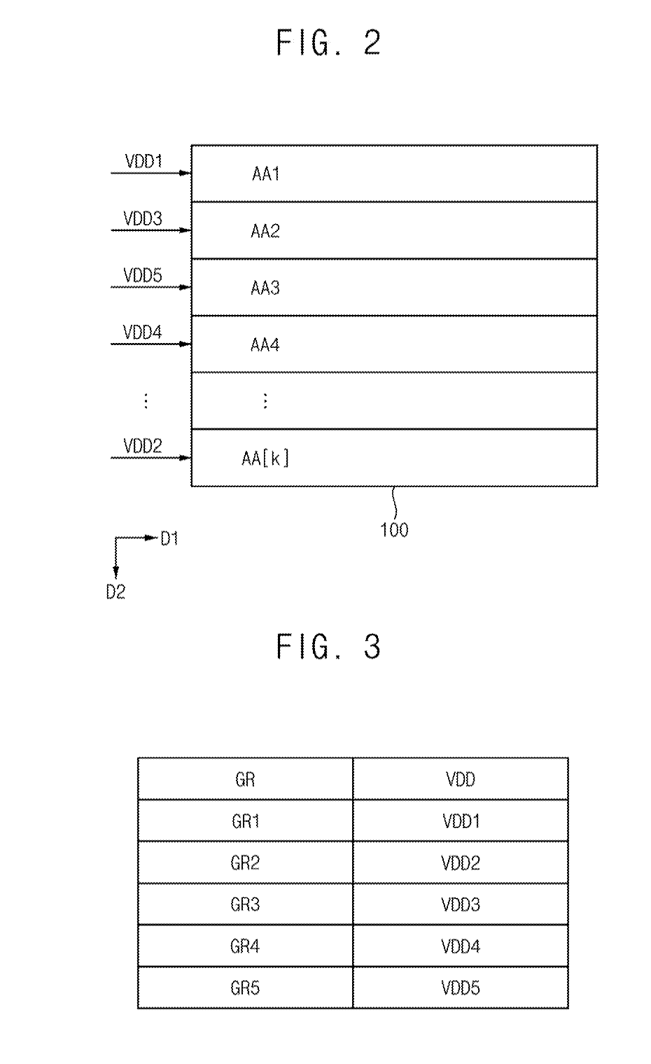

FIG. 2 is a block diagram illustrating an example of a high power voltage ELVDD applied to the display panel 100 included in the display device 1 of FIG. 1. FIG. 3 is a table illustrating a determined grayscale DGR and a high power voltage level VDD corresponding to the determined grayscale DGR of the display panel 100 of FIG. 1.

Referring to FIGS. 1 to FIG. 3, the display panel 100 may include first to K-th display regions AA1, AA2, AA3, AA4to AA[k]. Herein, K may be a positive integer. The second display region AA2 may be located adjacent to the first display region AA1 in the second direction D2. The third display region AA3 may be located adjacent to the second display region AA2 in the second direction D2. The fourth display region AA4 may be located adjacent to the third display region AA3 in the second direction D2.

In the present embodiment, the high power voltage ELVDD applied to the first display region AA1 and the high power voltage ELVDD applied to the second display region AA2 may be different. The high power voltage ELVDD applied to the second display region AA2 and the high power voltage ELVDD applied to the third display region AA3 may be different. The high power voltage ELVDD applied to the third display region AA3 and the high power voltage ELVDD applied to the fourth display region AA4 may be different. The high power voltage ELVDD applied to the fourth display region AA4 and the high power voltage ELVDD applied to the K-th display region AA[K] may be different.

For example, a first high power voltage level VDD1 may be applied to the first display region AA1. For example, a third high power voltage level VDD3 may be applied to the second display region AA2. For example, a fifth high power voltage level VDD5 may be applied to the third display region AA3. For example, a fourth high power voltage level VDD4 may be applied to the fourth display region AA4. For example, a second high power voltage level VDD2 may be applied to the K-th display region AA[k].

In the present embodiment, the high power voltage level VDD of the high power voltage ELVDD may be changed based on a grayscale displayed on the display region. When the grayscale displayed on the display region is increased, the high power voltage ELVDD may be increased. When the grayscale displayed on the display region is decreased, the high power voltage ELVDD may be decreased.

For changing the high power voltage ELVDD, the determined grayscale DGR of the display region may be determined. For example, a maximum grayscale among grayscales displayed by the pixel circuits PX included in the display region may be determined as the determined grayscale DGR of the display region. For example, when the display region includes a first pixel and a second pixel, and the first pixel emits light at about a 5 grayscale level and the second pixel emits light at about a 127 grayscale level, the grayscale of the display region may be determined to be about a 127 grayscale level. The determined grayscale DGR of the display region may be determined based on a number of pixel circuits that emit light higher than a reference grayscale among the pixel circuits PX included in the display region. The reference grayscale may include a plurality of reference grayscales. For example, when a number of pixel circuits that emit light higher than a first reference grayscale is equal to or greater than a reference number, the determined grayscale DGR of the display region may be determined as the first reference grayscale level. For example, when a number of pixel circuits that emit light lower the first reference grayscale and greater than or equal to a second reference grayscale is greater than or equal to the reference number, the determined grayscale DGR of the display region may be determined as the second reference grayscale level. The grayscale levels of the reference grayscales and the reference number may be set by a user. However, the present disclosure is not limited to the method of determining the determined grayscale DGR of the display region.

For example, when the determine grayscale DGR of the K-th display region AA[k] has a first grayscale level GR1, the high power voltage ELVDD (e.g., the K-th high power voltage) applied to the K-th display region AA[k] may have the first high power voltage level VDD1.

For example, when the determined grayscale DGR of the K-th display region AA[k] has a second grayscale level GR2, the high power voltage ELVDD (e.g., the K-th high power voltage) applied to the K-th display region AA[k] may have a second high power voltage level VDD2. The second grayscale level GR2 may be higher than the first grayscale level GR1. The second high power voltage level VDD2 may be higher than the first high power voltage level VDD1.

For example, when the determined grayscale DGR of the K-th display region AA[k] has a third grayscale level GR3, the high power voltage ELVDD (e.g., the K-th high power voltage) applied to the K-th display region AA[k] may have a third high power voltage level VDD3. The third grayscale level GR3 may be higher than the second grayscale level GR2. The third high power voltage level VDD3 may be higher than the second high power voltage level VDD2.

For example, when the determined grayscale DGR of the K-th display region AA[k] has a fourth grayscale level GR4, the high power voltage ELVDD (e.g., the K-th high power voltage) applied to the K-th display region AA[k] may have a fourth high power voltage level VDD4. The fourth grayscale level GR4 may be higher than the third grayscale level GR3. The fourth high power voltage level VDD4 may be higher than the third high power voltage level VDD3.

For example, when the determined grayscale DGR of the K-th display region AA[k] has a fifth grayscale level GR5, the high power voltage ELVDD (e.g., the K-th high power voltage) applied to the K-th display region AA[k] may have a fifth high power voltage level VDD5. The fifth grayscale level GR5 may be higher than the fourth grayscale level GR4. The fifth high power voltage level VDD5 may be higher than the fourth high power voltage level VDD4.

Although the first to fifth grayscale levels GR1, GR2, GR3, GR4 and GR5 and the first to fifth high power voltage levels VDD1, VDD2, VDD3, VDD4 and VDD5 are illustrated in FIG. 3, the present disclosure is not limited to a number of grayscale levels and a number of high power voltage levels corresponding to the grayscale levels. For example, an L-th grayscale level and an L-th high power voltage level corresponding to the L-th grayscale level may be applied to the display region. Here, L may be a positive integer. Additionally, in a case of a grayscale level between the first grayscale level GR1 and the second grayscale level GR2, a high power voltage level corresponding to the grayscale level between the first grayscale level GR1 and the second grayscale level GR2 may have a voltage level between the first high power voltage level VDD1 and the second high power voltage level VDD2.

In the present embodiment, high power voltages ELVDD applied to display regions may be different, and a power consumption of the display device 1 may be reduced.

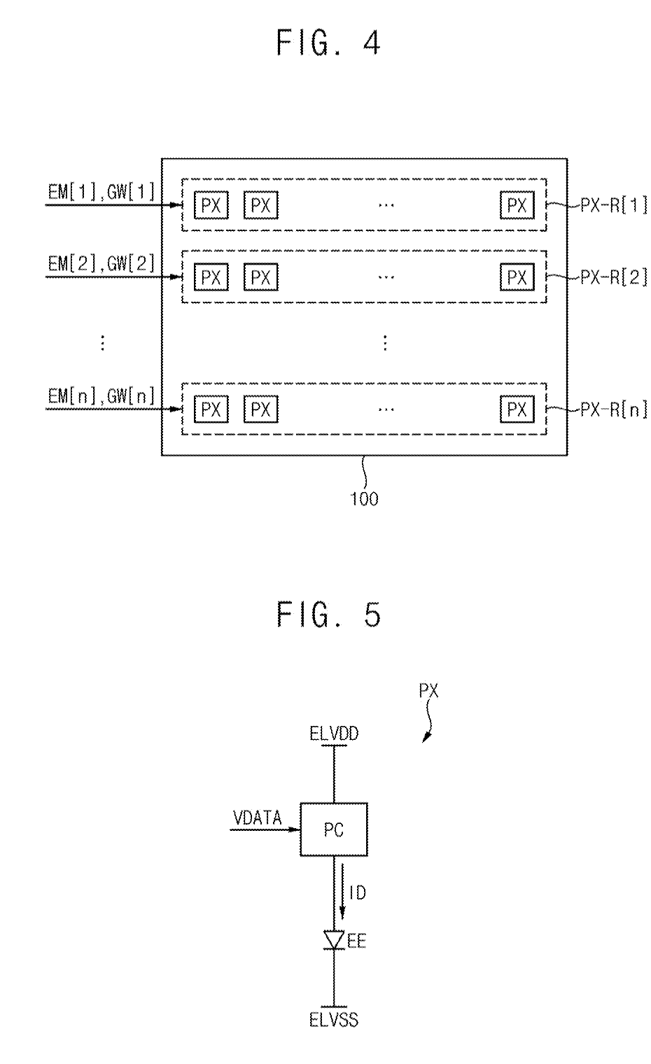

FIG. 4 is a block diagram illustrating an example of signals applied to the pixel circuit PX included in the display device 1 of FIG. 1.

Referring to FIGS. 1 to FIG. 4, the display panel 100 may include a plurality of pixel-rows PX-R[1], PXR[2] to PX-R[n]. A pixel-row may mean a plurality of pixel circuits PX connected to the same write gate line. For example, pixel circuits PX included in a pixel-row may receive the same write gate signal. Pixel circuits PX of a first pixel-row PX-R[1] may receive a first write gate signal GW[1]. Pixel circuits PX of a second pixel-row PX-R[2] may receive a second write gate signal GW[2]. Pixel circuits PX of an N-th pixel row PX-R[n] may receive an N-th write gate signal GW[n].

In the present embodiment, the write gate signals GW[1] … GW[n] may be sequential signals. Additionally, emission signals applied to the plurality of pixel-rows PX-R[1], PX-R[2] to PX-R[n] may be sequential signals. The sequential signals may mean signals applied to the plurality of pixel-rows PX-R[1], PX-R[2] to PX-R[n] with different timings. In an embodiment, the write gate signals GW[1] … GW[n] may be sequentially applied to the plurality of pixel-rows PX-R[1], PX-R[2] to PX-R[n].

A first emission signal EM[1] and the first write gate signal GW[1] may be applied to the first pixel-row PX-R[1]. A second emission signal EM[2] and the second write gate signal GW[2] may be applied to the second pixel-row PX-R[2]. An N-th emission signal EM[n] and the N-th write gate signal GW[n] may be applied to the N-th pixel-row PX-R[n].

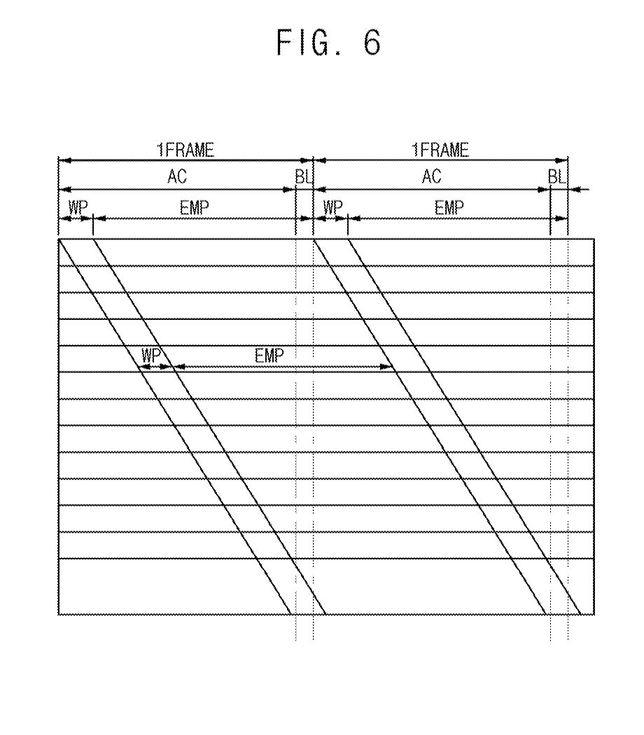

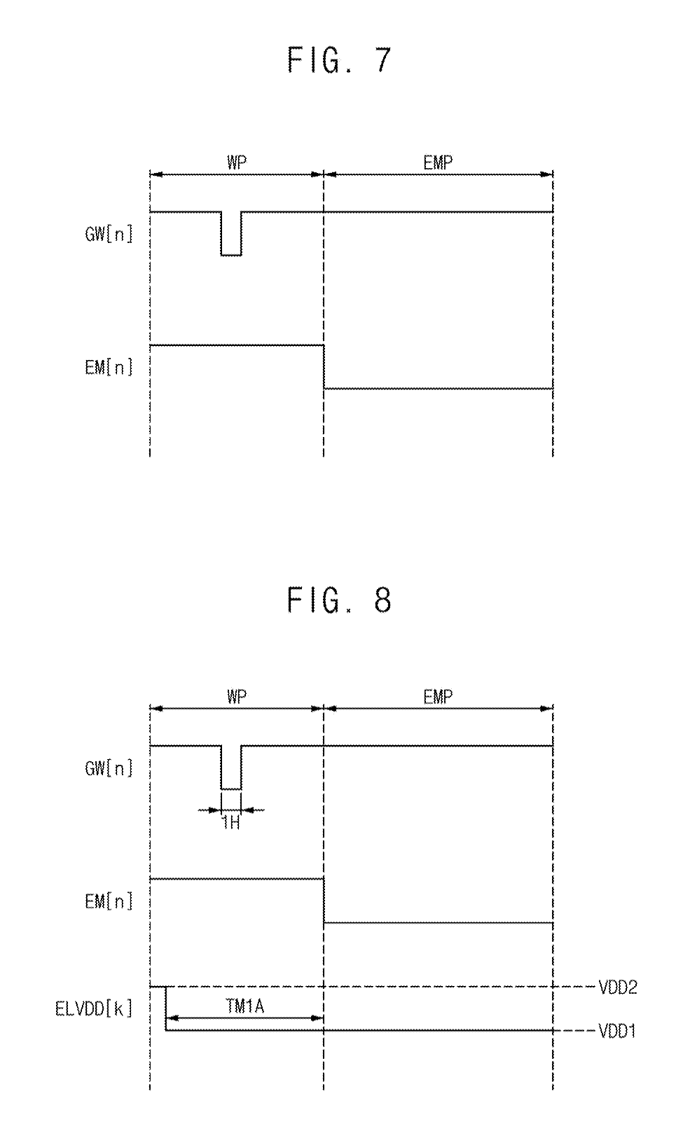

FIG. 5 is a circuit diagram illustrating an example of a pixel circuit PX included in the display device 1 of FIG. 1. FIG. 6 is a conceptual diagram illustrating a frame period of a display panel 100 included in the display device 1 of FIG. 1. FIG. 7 is a timing diagram illustrating an example of a write period WP and an emitting period EMP of FIG. 6.

Referring to FIGS. 1 to FIG. 7, the pixel circuit PX may include a circuit block PC and a light emitting element EE.

The circuit block PC may receive the data voltage VDATA and the high power voltage ELVDD. The circuit block PC may generate a driving current identifier (ID) based on the data voltage VDATA and the high power voltage ELVDD. The circuit block PC may include a driving transistor, a writing transistor, and an emitting transistor. The driving transistor may generate the driving current ID based on the data voltage VDATA. The writing transistor may apply the data voltage VDATA to the driving transistor in response to the write gate signal (hereinafter, representatively, GW[n]). The emitting transistor may control light emission of the light emitting element EE in response to the emission signal (hereinafter, representatively, EM[n]). The light emitting element EE may include a first electrode configured to receive the driving current ID and a second electrode configured to receive a second power voltage ELVSS. The light emitting element EE may emit light based on the driving current ID.

A frame period in which the display panel 100 is driven may include an active period AC and a blank period BL. In the active period AC, the data voltage VDATA may be applied to the display panel 100. In the blank period BL, an application of the data voltage VDATA to the display panel 100 may be stopped.

A frame period in which the pixel circuit PX is driven may include a write period WP and an emitting period EMP.

In the write period WP, the write gate signal GW[n] may have an activation level. Since the write gate signal GW[n] may have an activation level, the writing transistor may be turned on. When the writing transistor is turned on, the data voltage VDATA may be applied to the driving transistor. Additionally, in the write period WP, the emission signal EM[n] may have an inactivation level. When the emission signal EM[n] has an inactivation level, the emitting transistor may be turned off. When the emitting transistor is turned off, the light emitting element EE may stop emitting light. For example, the write period WP may be called as a non-emitting period.

In the emitting period EMP, the emission signal EM[n] may have an activation level. When the emission signal EM[n] has an activation level, the emitting transistor may be turned on. When the emitting transistor is turned on, the light emitting element EE may emit light based on the driving current ID.

The activation level may mean a level for turning on the transistor. For example, when the transistor is a P-type transistor, the activation level may be a logic low level. For example, when the transistor is an N-type transistor, the activation level may be a logic high level. The inactivation level may mean a level for turning off the transistor. For example, when the transistor is a P-type transistor, the inactivation level may be a logic high level. For example, when the transistor is an N-type transistor, the inactivation level may be a logic low level. While FIG. 7 describes that each of the write gate signal GW[n] and the emission signal EM[n] has an activation level of a logic low level and an inactivation level of a logic high level, the disclosure is not limited thereto.

In the present embodiment, in the write period WP, the high power voltage ELVDD may be changed. In the write period WP, the high power voltage ELVDD may be changed based on the determined grayscale DGR of the display region. Accordingly, compared to a case where the high power voltage ELVDD is changed in the emitting period EMP, a visibility of a flicker of the display panel 100 may be reduced. Accordingly, a display quality of the display panel 100 may be improved.

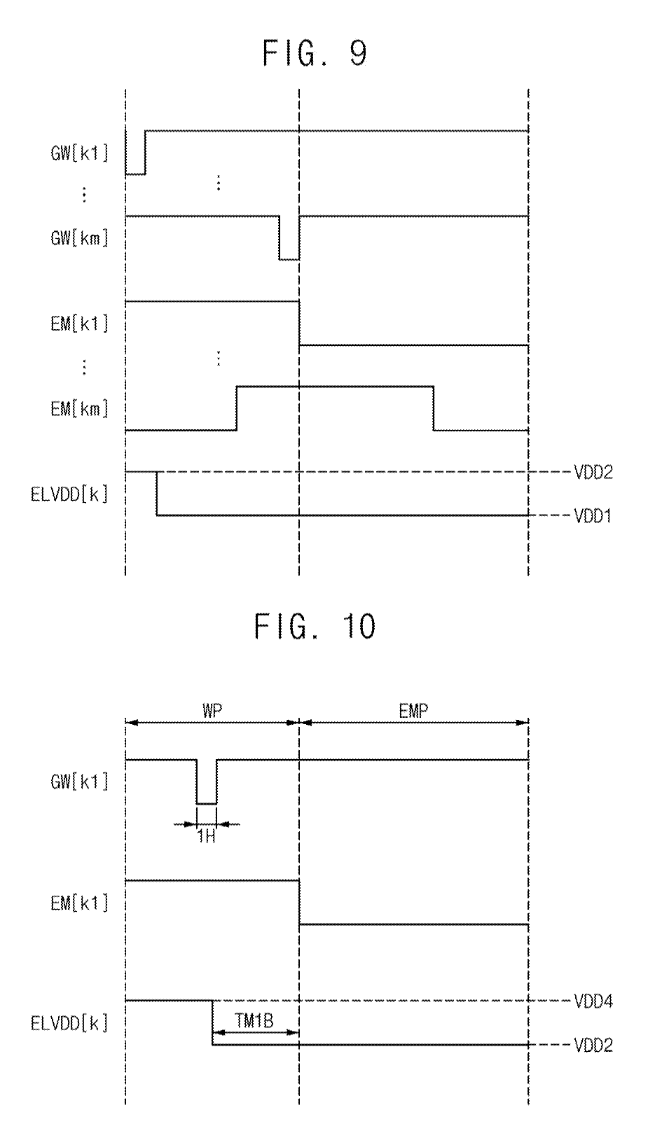

FIG. 8 is a timing diagram illustrating signals applied to a pixel circuit of the pixel circuits PX included in the K-th display region AA[k] included in the display panel 100 of FIG. 2. FIG. 9 is a timing diagram illustrating signals applied to the K-th display region AA[k] included in the display panel 100 of FIG. 2.

Referring to FIGS. 1 to FIG. 9, the K-th display region AA[k] may include first to M-th pixel-rows. The first to M-th pixel-rows may be located sequentially. Herein, M may be a positive integer. The first to M-th pixel-rows may receive first to M-th write gate signals GW[k1] to GW[km], first to M-th emission signals EM[k1] to EM[km], and K-th high power voltage ELVDD[k].

The first pixel-row may refer to a pixel-row which is first located in the K-th display region AA[k]. A pixel circuit included in the first pixel-row may receive the first write gate signal GW[k1], the first emission signal EM[k1] and the K-th high power voltage ELVDD[k]. In the write period WP, the first write gate signal GW[k1] may have an activation level. In the write period WP, the first emission signal EM[k1] may have an inactivation level. In the write period WP, the first write gate signal GW[k1] may have an activation level during a first write time 1H. In the write period WP, the K-th high power voltage ELVDD[k] may be changed. The K-th high power voltage ELVDD[k] may be changed before a first time TM1A (or a period or a duration of the first time TM1A) from the emitting period EMP. For example, the K-th high power voltage ELVDD[k] may be changed from the second high power voltage level VDD2 to the first high power voltage level VDD1 before the first time TM1A from a time at which the first emission signal EM[k1] transitions to an activation level.

In an embodiment, the first time TM1A may be set based on a number of pixel-rows included in the K-th display region AA[k]. For example, the first time TM1A may be set by the user based on a number of first to M-th pixel-rows included in the K-th display region AA[k]. For example, when the K-th display region AA[k] includes about 25 pixel-rows (e.g., 25 pixel-rows), the first time TM1A may be a time obtained by multiplying the first write time 1H by about 25 times (e.g., 25 times). For example, when the K-th display region AA[k] includes about 154 pixel-rows, the first time TM1A may be a time obtained by multiplying the first write time 1H by about 154 times. However, the present disclosure is not limited to the number of pixel-rows included in the K-th display region AA[k]. For example, when the K-display region AA[k] includes about 200 pixel-rows, the first time TM1A may be a time obtained by multiplying the first write time 1H by about 200 times.

In the present embodiment, the K-th high power voltage ELVDD[k] may be changed in the write period WP. For example, the K-th high power voltage ELVDD[k] may be changed in the non-emitting period. For example, the K-th high power voltage ELVDD[k] may be changed before the first time TM1A from the emitting period EMP. Accordingly, the visibility of the flicker of the display panel 100 may be reduced compared to a case where the high power voltage ELVDD is changed in the emitting period EMP. Accordingly, the display quality of the display panel 100 may be improved.

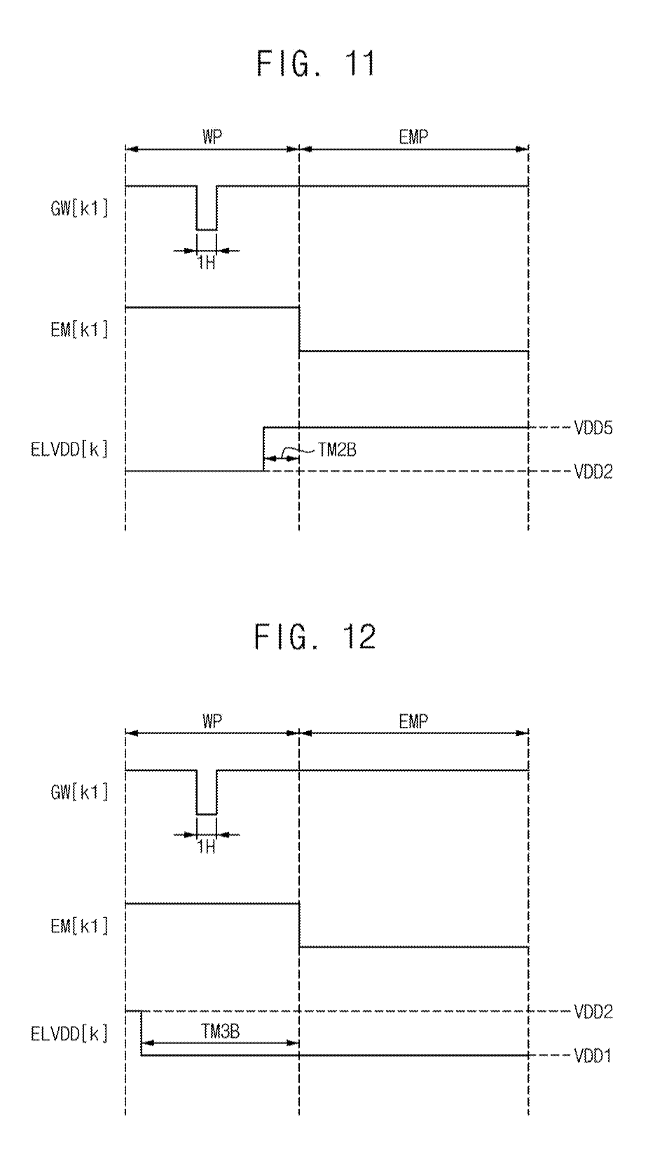

FIG. 10 is a timing diagram illustrating signals applied to a pixel circuit of the pixel circuits PX included in the K-th display region AA[k] included in the display panel 100 of FIG. 2. FIG. 11 is a timing diagram illustrating signals applied to a pixel circuit of the pixel circuits PX included in the K-th display region AA[k] included in the display panel 100 of FIG. 2. FIG. 12 is a timing diagram illustrating signals applied to a pixel circuit of the pixel circuits PX included in the K-th display region AA[k] included in the display panel 100 of FIG. 2.

Referring to FIGS. 1 to FIG. 7 and FIGS. 10 to FIG. 12, the K-th display region AA[k] may include first to M-th pixel-rows. The first to M-th pixel-rows may be located sequentially.

The first pixel-row may refer to a pixel row which is firstly located in the K-th display region AA[k]. A pixel circuit included in the first pixel-row may receive the first write gate signal GW[k1], the first emission signal EM[k1], and the K-th high power voltage ELVDD[k]. In the write period WP, the first write gate signal GW[k1] may have an activation level. In the write period WP, the first emission signal EM[k1] may have an inactivation level. In the write period WP, the first write gate signal GW[k1] may have an activation level during the first write time 1H. In the write period WP, the K-th high power voltage ELVDD[k] may be changed. The K-th high power voltage ELVDD[k] may be changed before a first time TM1B from the emitting period EMP. For example, the K-th high power voltage ELVDD[k] may be changed from the second high power voltage level VDD2 to the first high power voltage level VDD1 before the first time TM1B from a time at which the first emission signal EM[k1] transitions to an activation level.

In the present embodiment, in the write period WP, a time point at which the K-th high power voltage ELVDD[k] is changed may be changed based on the determined grayscale DGR of the K-th display region AA[k]. For example, in the write period WP, the time point at which the K-th high power voltage ELVDD[k] is changed may be changed based on the determined grayscale DGR of the K-th display region AA[k] in a current frame.

When the K-th display region AA[k] has the determined grayscale DGR of the first grayscale level GR1, the K-th high power voltage may be changed before the first time TM1B from the emitting period EMP. When the K-th display region AA[k] has the determined grayscale DGR of the first grayscale level GR1, the K-th high power voltage may be changed from the fourth high power voltage level VDD4 to the second high power voltage level VDD2 lower than the fourth high power voltage level VDD4 before the first time TM1B from the emitting period EMP. For example, the first grayscale level GR1 may be about 87 grayscale level. However, the present disclosure is not limited to the value of the first grayscale level GR1.

When the determined grayscale DGR of the K-th display region AA[k] is increased, the K-th high power voltage ELVDD[k] may be changed before a second time TM2B from the emitting period EMP. For example, when the determined grayscale DGR of the K-th display region AA[k] is the second grayscale level GR2 higher than the first grayscale level GR1, the K-th high power voltage ELVDD[k] may be changed before the second time TM2B from the emitting period EMP. For example, when the determined grayscale DGR of the K-th display region AA[k] is the second grayscale level GR2 higher than the first grayscale level GR1, the K-th high power voltage ELVDD[k] may be changed from the second high power voltage level VDD2 to the fifth high power voltage level VDD5 higher than the second high power voltage level VDD2 before the second time TM2B from the emitting period EMP. The second time TM2B may be shorter than the first time TM1B. For example, the second grayscale level GR2 may be about 127 grayscale level. However, the present disclosure is not limited to a value of the second grayscale level GR2.

When the determined grayscale DGR of the K-th display region AA[k] is decreased, the K-th high power voltage ELVDD[k] may be changed before a third time TM3B from the emitting period EMP. For example, when the determined grayscale DGR of the K-th display region AA[k] is a third grayscale level GR3 lower than the first grayscale level GR1, the K-th high power voltage ELVDD[k] may be changed before the third time TM3B from the emitting period EMP. For example, when the determined grayscale DGR of the K-th display region AA[k] is the third grayscale level GR3 lower than the first grayscale level GR1, the K-th high power voltage ELVDD[k] may be changed from the second high power voltage level VDD2 to the first high power voltage level VDD1 lower than the second high power voltage level VDD2 before the third time TM3B from the emitting period EMP. The third time TM2B may be longer than the first time TM1B. For example, the third grayscale level GR3 may be about 31 grayscale level. However, the present disclosure is not limited to a value of the third grayscale level GR3.

In the present embodiment, in the write period WP, the time point at which the Kth high power voltage ELVDD[k] is changed may be changed based on the determined grayscale DGR of the K-th display region AA[k]. Accordingly, even when an image displayed on the K-th display region AA[k] is a low grayscale image, the flicker visibility may be further reduced. Accordingly, the display quality of the display panel 100 may be further improved. Additionally, even when an image displayed on the K-th display region AA[k] is a high grayscale image, the flicker visibility may be further reduced. Accordingly, the display quality of the display panel 100 may be further improved.

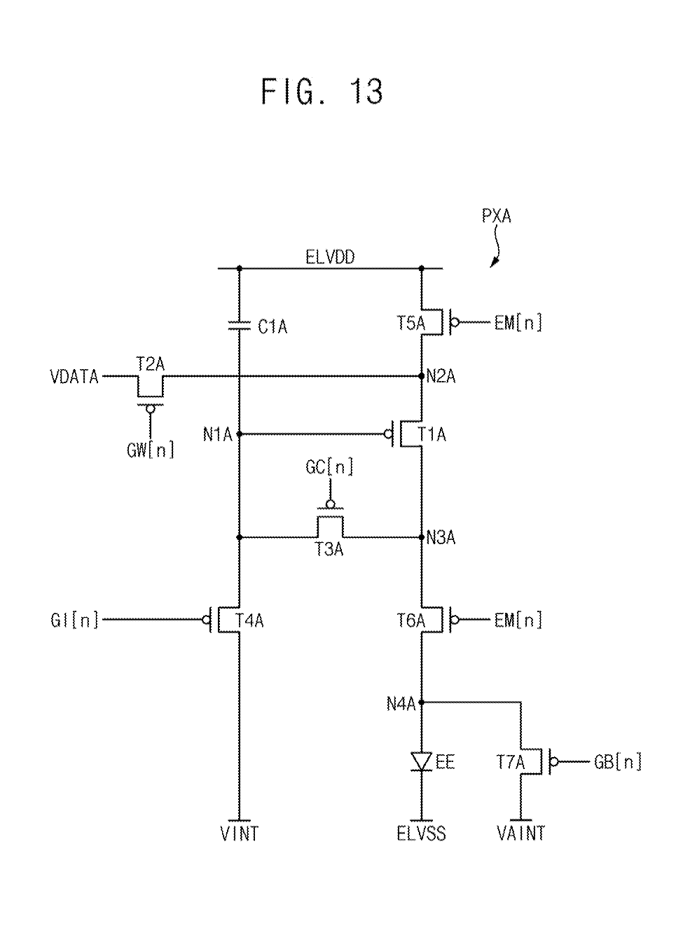

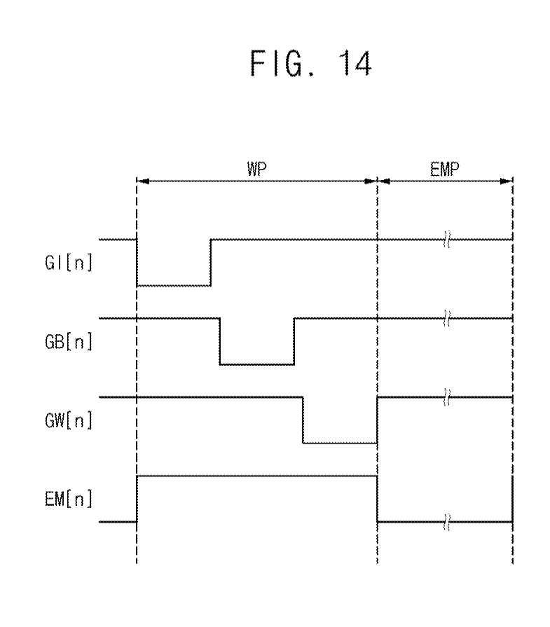

FIG. 13 is a circuit diagram illustrating an example of a pixel circuit PX included in the display device 1 of FIG. 1. FIG. 14 is a timing diagram illustrating an example of signals applied to a pixel circuit PXA of FIG. 13.

Referring to FIGS. 1, FIG. 13, and FIG. 14, a pixel circuit PXA may include a first transistor T1A, a second transistor T2A, a third transistor T3A, a fourth transistor T4A, a fifth transistor T5A, a sixth transistor T6A, a seventh transistor T7A, a first capacitor C1A and a light emitting element EE.

The first transistor T1A may include a control electrode connected to a first node N1A, a first electrode connected to a second node N2A, and a second electrode connected to a third node N3A. The first transistor T1A may generate a driving current based on a voltage of the first node N1A. For example, the first transistor T1A may be called as the driving transistor. In the present embodiment, the first transistor T1A may be a P-type transistor as an example.

The second transistor T2A may include a control electrode configured to receive the write gate signal GW[n], a first electrode configured to receive the data voltage VDATA and a second electrode connected to the second node N2A. The second transistor T2A may apply the data voltage VDATA to the second node N2A in response to the write gate signal GW[n]. For example, the second transistor T2A may be called as a writing transistor.

The third transistor T3A may include a control electrode configured to receive a compensation gate signal GC[n], a first electrode connected to the third node N3A, and a second electrode connected to the first node N1A. The third transistor T3A may connect the first node N1A and the third node N3A in response to the compensation gate signal GC[n]. For example, the third transistor T3A may diode-connect the first transistor T1A in response to the compensation gate signal GC[n]. For example, the third transistor T3A may be called as a compensation transistor.

The fourth transistor T4A may include a control electrode configured to receive an initialization gate signal GI[n], a first electrode configured to receive an initialization voltage VINT, and a second electrode connected to the first node N1A. The fourth transistor T4A may apply the initialization voltage VINT to the first node N1A in response to the initialization gate signal GI[n]. For example, the fourth transistor T4A may be called as an initialization transistor.

The fifth transistor T5A may include a control electrode configured to receive the emission signal EM[n], a first electrode configured to receive the high power voltage ELVDD, and a second electrode connected to the second node N2A. The fifth transistor T5A may apply the first power voltage ELVDD to the second node N2A in response to the emission signal EM[n]. For example, the fifth transistor T5A may be called as a first emission transistor.

The sixth transistor T6A may include a control electrode configured to receive the emission signal EM[n], a first electrode connected to the third node N3A, and a second electrode connected to a fourth node N4A. The sixth transistor T6A may connect the third node N3A and the fourth node N4A in response to the emission signal EM[n]. For example, the sixth transistor T6A may be called as a second emission transistor.

The seventh transistor T7A may include a control electrode configured to receive a light emitting element initialization gate signal GB[n], a first electrode configured to receive a light emitting element initialization voltage VAINT, and a second electrode connected to the fourth node N4A. The seventh transistor T7A may apply the light emitting element initialization voltage VAINT to the fourth node N4A in response to the light emitting element initialization gate signal GB[n].

The first capacitor C1A may include a first electrode configured to receive the first power voltage ELVDD and a second electrode connected to the first node N1A. The first capacitor C1A may store a voltage of the first node N1A. For example, the first capacitor C1A may be called as a storage capacitor.

The light emitting element EE may include a first electrode connected to the fourth node N4A and a second electrode configured to receive the low power voltage ELVSS. The light emitting element EE may emit light based on the driving current.

In the write period WP, the initialization gate signal GI[n], the light emitting element initialization gate signal GB[n], and the write gate signal GW[n] may have activation levels. In the write period WP, the emission signal EM[n] may have an inactivation level. In the emitting period EMP, the initialization gate signal GI[n], the light emitting element initialization gate signal GB[n], and the write gate signal GW[n] may have inactivation levels. In the emitting period EMP, the emission signal EM[n] may have an activation level.

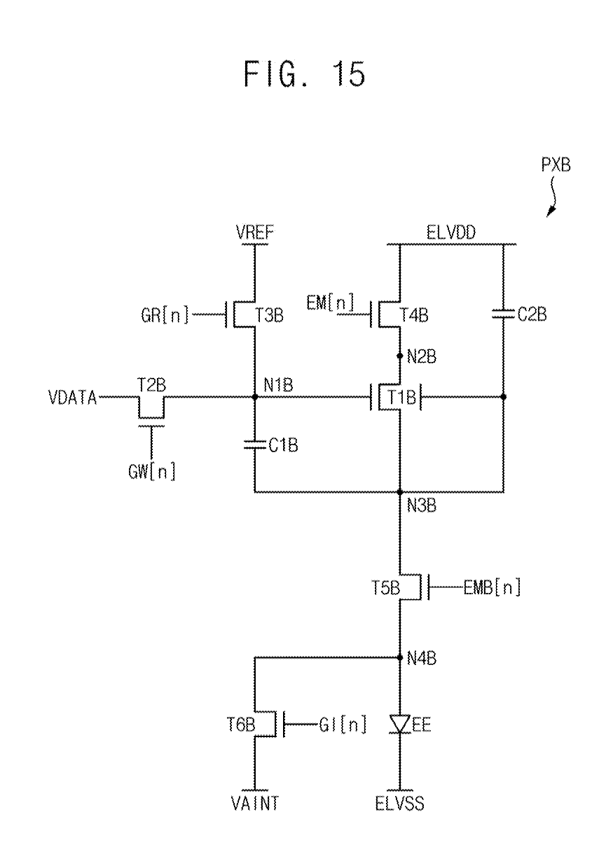

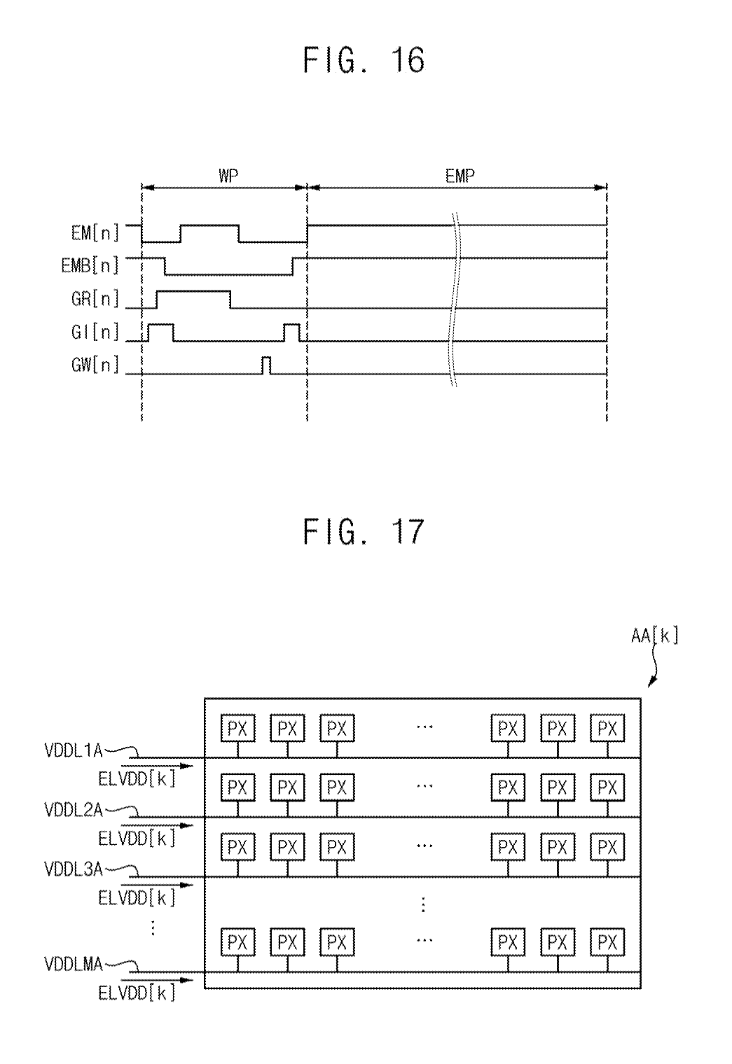

FIG. 15 is a circuit diagram illustrating an example of a pixel circuit PX included in the display device 1 of FIG. 1. FIG. 16 is a timing diagram illustrating an example of signals applied to a pixel circuit PXB of FIG. 15.

Referring to FIGS. 1, FIG. 15, and FIG. 16, a pixel circuit PXB may include a first transistor T1B, a second transistor T2B, a third transistor T3B, a fourth transistor T4B, a fifth transistor T5B, a sixth transistor T6B, a first capacitor C1B, and the light emitting element EE. In an embodiment, the pixel circuit PXB may further include a second capacitor C2B.

The first transistor T1B may include a control electrode connected to a first node N1B, a first electrode connected to a second node N2B, and a second electrode connected to a third node N3B. The first transistor T1B may generate the driving current based on a voltage of the first node N1B. In an embodiment, the first transistor T1B may further include a second control electrode connected to the third node N3B. For example, the first transistor T1B may be called as the driving transistor. In the present embodiment, the first transistor T1B may be an N-type transistor.

The second transistor T2B may include a control electrode configured to receive the write gate signal GW[n], a first electrode configured to receive the data voltage VDATA, and a second electrode connected to the first node N1B. The second transistor T2B may apply the data voltage VDATA to the first node N1B in response to the write gate signal GW[n]. For example, the second transistor T2B may be called as the writing transistor.

The third transistor T3B may include a control electrode configured to receive the reset gate signal GR[n], a first electrode configured to receive a pixel reference voltage VREF, and a second electrode connected to the first node N1B. The third transistor T3B may apply the pixel reference voltage VREF to the first node N1B in response to the reset gate signal GR[n]. For example, the third transistor T3B may be called as the initialization transistor.

The fourth transistor T4B may include a control electrode configured to receive the emission signal EM[n], a first electrode configured to receive the high power voltage ELVDD, and a second electrode connected to the second node N2B. The fourth transistor T4B may apply the high power voltage ELVDD to the second node N2B in response to the emission signal EM[n]. For example, the fourth transistor T4B may be called as the first emission transistor.

The fifth transistor T5B may include a control electrode configured to receive a second emission signal EMB[n], a first electrode connected to the third node N3B, and a second electrode connected to a fourth node N4B. The fifth transistor T5B may connect the third node N3B and the fourth node N4B in response to the second emission signal EMB[n]. For example, the fifth transistor T5B may be called as the second emitting transistor.

The sixth transistor T6B may include a control electrode configured to receive the initialization gate signal GI[n], a first electrode configured to receive the light emitting element initialization voltage VAINT, and a second electrode connected to the fourth node N4B. The sixth transistor T6B may apply the light emitting element initialization voltage VAINT to the fourth node N4B in response to the initialization gate signal GI[n]. For example, the sixth transistor T6B may be called as the light emitting element initialization transistor.

The first capacitor C1B may include a first electrode connected to the first node N1B and a second electrode connected to the third node N3B. The second capacitor C2B may include a first electrode configured to receive the high power voltage ELVDD and a second electrode connected to the third node N3B.

The light emitting element EE may include a first electrode connected to the fourth node N4B and a second electrode configured to receive the second power voltage ELVSS. The light emitting element EE may emit light based on the driving current.

In the write period WP, the initialization gate signal GI[n], the reset gate signal GR[n], and the write gate signal GW[n] may have activation levels. In the emitting period EMP, the initialization gate signal GI[n], the reset gate signal GR[n], and the write gate signal GW[n] may have inactivation levels. In the emitting period EMP, the emission signal EM[n] and the second emission signal EMB[n] may have activation levels.

FIG. 17 is a block diagram illustrating an example of the K-th display region AA[k] and high power voltage lines included in the display panel 100 of FIG. 2.

The K-th display region AA[k] may include first to M-th pixel-rows and first to M-th high power voltage lines VDDL1A, VDDL2A, VDDL3A to VDDLMA. The first to M-th pixel-rows may be sequentially located in the second direction D2. The first high power voltage line VDDL1A may be connected to the first pixel-row. The second high power voltage line VDDL2A may be connected to the second pixel-row. The third high power voltage line VDDL3A may be connected to the third pixel-row. The M-th high power voltage line VDDLMA may be connected to the M-th pixel-row. The first to M-th high power voltage lines VDDL1A, VDDL2A, VDDL3A to VDDLMA may output the K-th high power voltage ELVDD[k].

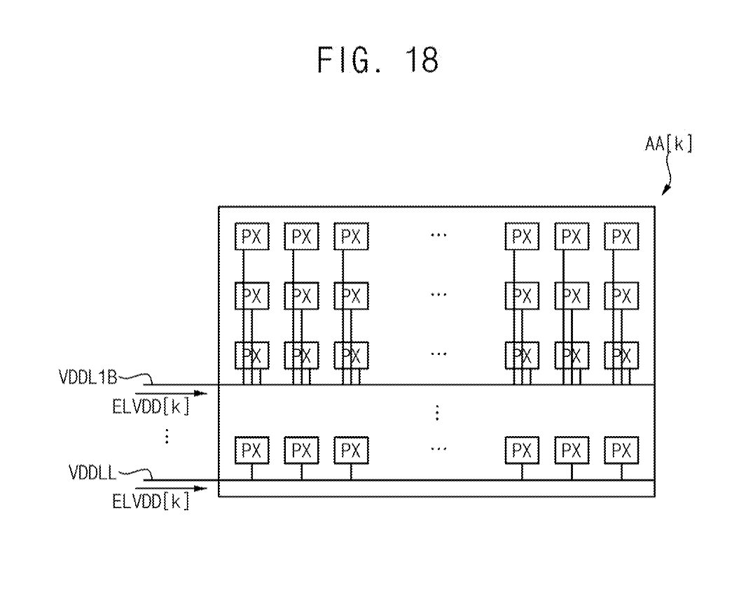

FIG. 18 is a block diagram illustrating an example of the K-th display region AA[k] and high power voltage lines included in the display panel 100 of FIG. 2.

The K-th display region AA[k] may include first to M-th pixel-rows and first to L-th high power voltage lines VDDL1B to VDDLL. Herein, L may be a positive integer. The first to M-th pixel-rows may be sequentially located in the second direction D2. The first high power voltage line VDDL1B may be connected to the first pixel-row, the second pixel-row, and the third pixel-row. The L-th high power voltage line VDDLL may be connected to the M-2-th pixel-row, the M-1-th pixel-row, and the M-th pixel-row. The first to L-th high power voltage lines VDDL1B to VDDLL may output the K-th high power voltage ELVDD[k]. The present disclosure is not limited to a number of pixel-rows to which one high power voltage line is connected.

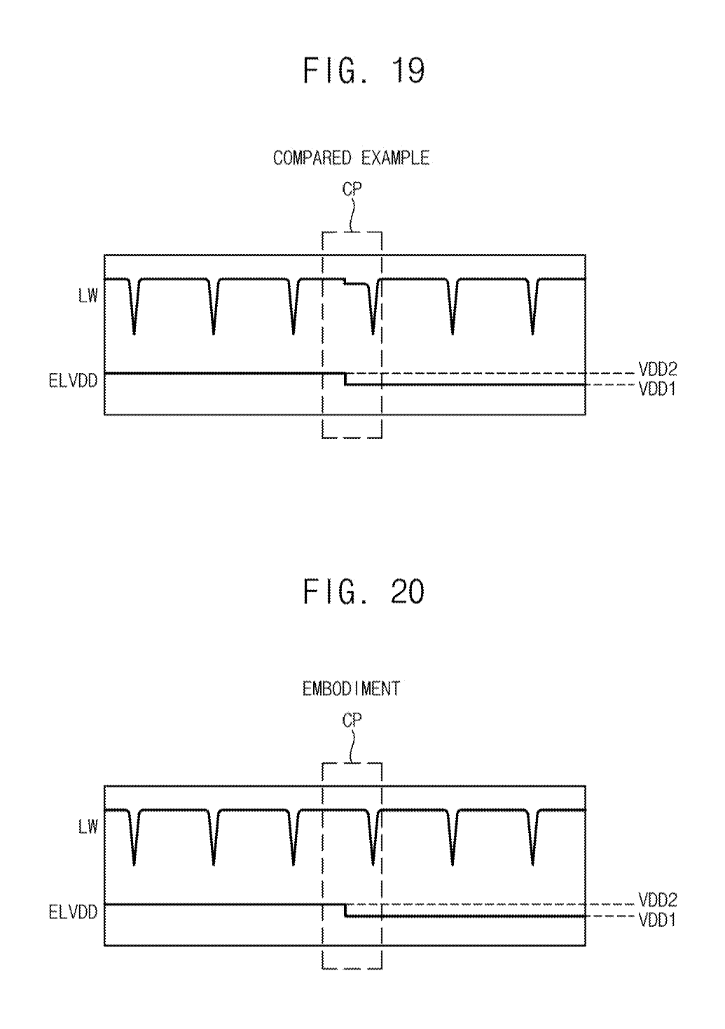

FIG. 19 is a graph illustrating changes in a luminance waveform LW according to changes in a high power voltage ELVDD in a display device according to a comparative example. FIG. 20 is a graph illustrating changes in a luminance waveform LW according to changes in a high power voltage ELVDD in a display device 1 of FIG. 1.

Referring to FIGS. 1 to FIG. 20, the display device according to the comparative example may change the high power voltage ELVDD in the emitting period EMP. In the display device according to the comparative example, when the high power voltage ELVDD is changed from the first high power voltage level VDD1 to the second high power voltage level VDD2, the luminance waveform LW may change. For example, the luminance waveform LW may change at a section CP at which the high power voltage ELVDD is changed from the first high power voltage level VDD1 to the second high power voltage level VDD2. Accordingly, a display quality of the display panel may be deteriorated.

In contrast, the display device 1 may change the high power voltage ELVDD in the write period WP (e.g., the non-emitting period). In the write period WP, when the high power voltage ELVDD is changed from the first high power voltage level VDD1 to the second high power voltage level VDD2, the luminance waveform LW may be maintained. For example, the luminance waveform LW may be maintained at the section CP. Accordingly, the display quality of the display panel 100 may be improved.

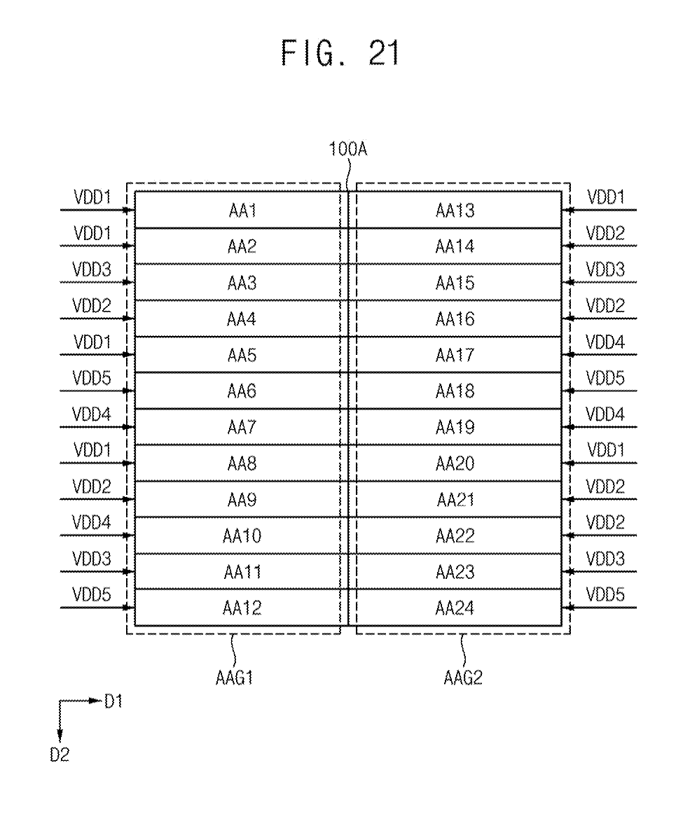

FIG. 21 is a block diagram illustrating an example of a high power voltage ELVDD applied to a display panel 100 included in the display device 1 of FIG. 1.

Referring to FIGS. 1 and FIG. 21, a display panel 100A may include a first display region group AAG1 and a second display region group AAG2. For example, the display panel 100A may correspond to the display panel 100 included in the display device 1 of FIG. 1. The second display region group AAG2 may be located adjacent to the first display region group AAG1 in the first direction D1. The first display region group AAG1 may include first to twelfth display regions AA1, AA2, AA3, AA4, AA5, AA6, AA7, AA8, AA9, AA10, AA11 and AA12. The second display region group AAG2 may include thirteenth to twenty-fourth display regions AA13, AA14, AA15, AA16, AA17, AA18, AA19, AA20, AA21, AA22, AA23 and AA24.

For example, the first high power voltage level VDD1 may be applied to the first display region AA1. For example, the first high power voltage level VDD1 may be applied to the second display region AA2. For example, the third high power voltage level VDD3 may be applied to the third display region AA3. For example, the second high power voltage level VDD2 may be applied to the fourth display region AA4. For example, the first high power voltage level VDD1 may be applied to the fifth display region AA5. For example, a fifth high power voltage level VDD5 may be applied to the sixth display region AA6. For example, the fourth high power voltage level VDD4 may be applied to the seventh display region AA7. For example, the first high power voltage level VDD1 may be applied to the eighth display region AA8. For example, the second high power voltage level VDD2 may be applied to the ninth display region AA9. For example, the fourth high power voltage level VDD4 may be applied to the tenth display region AA10. For example, the third high power voltage level VDD3 may be applied to the eleventh display region AA11. For example, the fifth high power voltage level VDD5 may be applied to the twelfth display region AA12. For example, the first high power voltage level VDD1 may be applied to the thirteenth display region AA13. For example, the second high power voltage level VDD2 may be applied to the fourteenth display region AA14. For example, the third high power voltage level VDD3 may be applied to the fifteenth display region AA15. For example, the second high power voltage level VDD2 may be applied to the sixteenth display region AA16. For example, the fourth high power voltage level VDD4 may be applied to the seventeenth display region AA17. For example, the fifth high power voltage level VDD5 may be applied to the eighteenth display region AA18. For example, the fourth high power voltage level VDD4 may be applied to the nineteenth display region AA19. For example, the first high power voltage level VDD1 may be applied to the twentieth display region AA20. For example, the second high power voltage level VDD2 may be applied to the twenty-first display region AA21. For example, the second high power voltage level VDD2 may be applied to the twenty-second display region AA22. For example, the third high power voltage level VDD3 may be applied to a twenty-third display region AA23. For example, the fifth high power voltage level VDD5 may be applied to the twenty-fourth display region AA24.

In the present embodiment, different high power voltages ELVDD may be applied to the first display region group AAG1 and the second display region group AAG2. For example, one of different high power voltages ELVDD may be applied to each of the first to twenty-fourth display regions AA1 to AA24. Accordingly, a power consumption of the display device 1 may be further reduced.

Additionally, the display device 1 may change the high power voltage ELVDD in the write period WP (e.g., the non -emitting period). In the write period WP, when the high power voltage ELVDD is changed from the first high power voltage level VDD1 to the second high power voltage level VDD2, the luminance waveform may be maintained. Accordingly, the display quality of the display panel 100 may be improved.

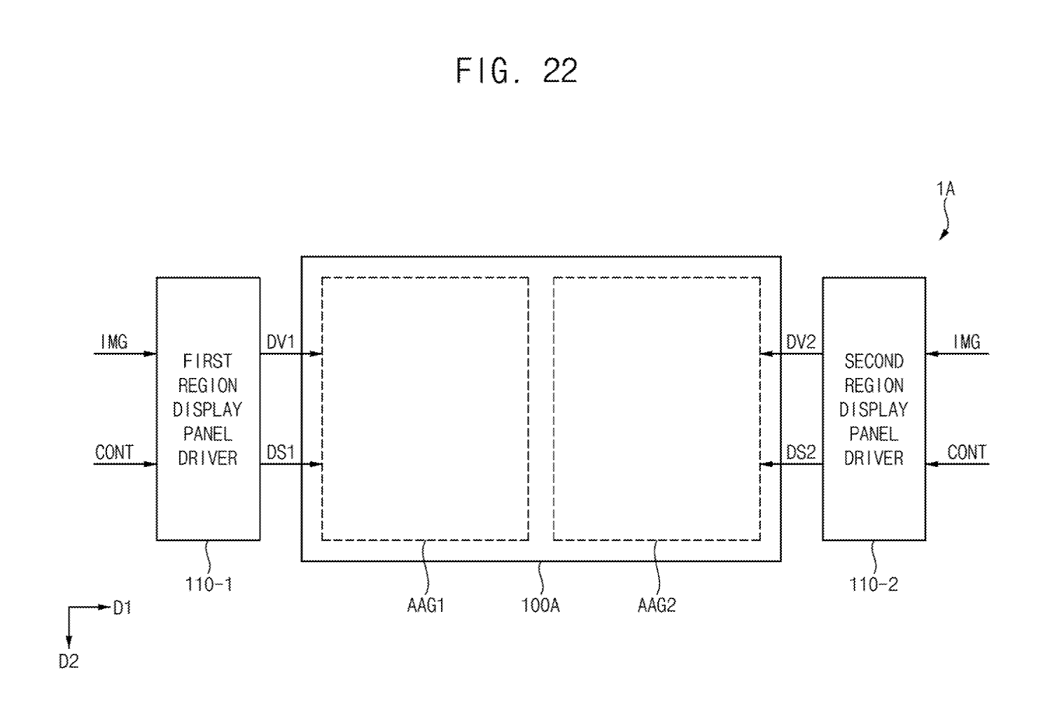

FIG. 22 is a block diagram illustrating a display device 1A according to one or more embodiments of the present disclosure.

Referring to FIG. 22, the display device 1A may include the display panel 100A, a first region display panel driver 110-1, and a second region display panel driver 110-2. The display panel 100A may include the first display region group AAG1 and the second display region group AAG2. The second display region group AAG2 may be located adjacent to the first display region group AAG1 in the first direction D1. The first region display panel driver 110-1 may drive the first display region group AAG1 based on the input image data IMG and the input control signal CONT. The first region display panel driver 110-1 may output a first driving voltage DV1 and a first driving signal DS1 based on the input image data IMG and the input control signal CONT. The first driving voltage DV1 may include power voltages. The first driving signal DS1 may include the gate signal and the emission signal. The second region display panel driver 110-2 may drive the second display region group AAG2 based on the input image data IMG and the input control signal CONT. The second region display panel driver 110-2 may output a second driving voltage DV2 and a second driving signal DS2 based on the input image data IMG and the input control signal CONT. The second driving voltage DV2 may include power voltages. The second driving signal DS2 may include the gate signal and the emission signal.

The display device 1A may be substantially same as the display device 1 of FIG. 1, except that the display device 1A includes the first display region group AAG1, the second display region group AAG2, the first region display panel driver 110-1, and the second region display panel driver 110-2, and the same reference numerals will be used and any repetitive explanation concerning the above elements will be omitted.

In the present embodiment, different high power voltages ELVDD may be applied to the first display region group AAG1 and the second display region group AAG2. For example, different high power voltages ELVDD may be applied to each of the first to twenty-fourth display regions AA1 to AA24. Accordingly, a power consumption of the display device 1A may be further reduced.

Additionally, in the present embodiment, the first display region group AAG1 may be driven by the first region display panel driver 110-1. The second display region group AAG2 may be driven by the second region display panel driver 110-2. Accordingly, the first display region group AAG1 and the second display region group AAG2 may be driven based on different display panel drivers. Accordingly, a driving diversity of the display panel 100A may be improved. For example, the power consumption of the display device 1A may be further reduced.

Additionally, the display device 1A may change the high power voltage ELVDD in the write period WP (e.g., the non -emitting period). The high power voltage ELVDD for a corresponding display region may be changed based on a grayscale displayed on the corresponding display region. In the write period WP, when the high power voltage ELVDD is changed from the first high power voltage level VDD1 to the second high power voltage level VDD2, the luminance waveform may be maintained. Accordingly, the display quality of the display panel 100A may be improved.

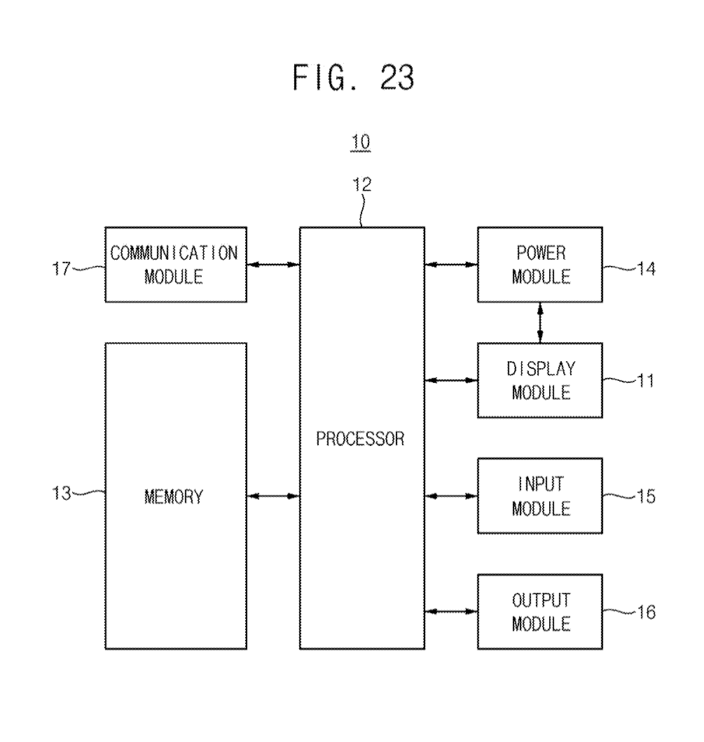

FIG. 23 is a block diagram illustrating an electronic device 10 according to one or more embodiments of the present disclosure.

Referring to FIG. 23, an electronic device 10 according to an embodiment may include a display module 11, at least one processor 12, at least one memory 13, and a power module 14.

The at least one processor 12 may include at least one of a central processing unit (CPU), an application processor (AP), a graphic processing unit (GPU), a communication processor (CP), an image signal processor (ISP), and a controller.

The at least one memory 13 may store data information necessary for the operation of the at least one processor 12 or the display module 11. When the at least one processor 12 executes an application stored in the at least one memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power required for the operation of the electronic device 10.

The electronic device 10 may further include an input module 15, a non-image output module 16 and/or a communication module 17.

The input module 15 may provide input information to the at least one processor 12 and/or the display module 11. The input module 15 may include various sensor modules as well as physical buttons, a keyboard, and a microphone. Examples of the sensor modules may include, for example but not limited to, a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the at least one processor 12 and provide the information to the user. Examples of the non-image output module 16 may include, for example but not limited to, an audio module, a haptic module, a light-emitting module, etc., and may include other functional modules used in the electronic device 10 (e.g., a cooling module of a refrigerator, etc.).

The communication module 17 may transmit and receive information between the electronic device 10 and an external device, and may include a receiving unit and a transmitting unit. The communication module 17 may include various wireless communication modules such as, for example but not limited to, a mobile communication module, a Wi-Fi module, a Bluetooth module, or various wired communication modules.

At least one of the components of the electronic device 10 described above may be included in the display device according to one or more embodiments described above. Additionally, some of the individual modules functionally included in one module may be included in the display device, and other may be provided separately from the display device. For example, the display device may include the display module 11, and the at least one processor 12, the at least one memory 13, and the power module 14 may be provided in a form of other devices within the electronic device 10 other than the display device.

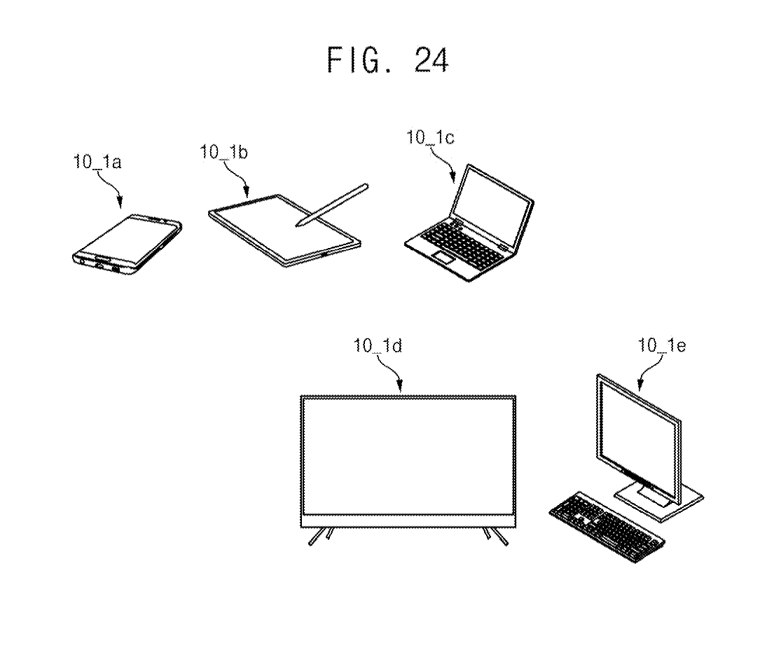

FIGS. 24 to FIG. 26 are schematic diagrams illustrating an electronic device according to one or more embodiments.

Referring to FIG. 24, a smartphone 10_1a, a tablet PC 10_1b, a laptop 10_1c, a TV 10_1d, and a desk monitor 10_1e may be examples of electronic devices.

The smartphone 10_1a may include an input module such as a touch sensor and a communication module in addition to the display module 11. The smartphone 10_1a may process information received through the communication module or other input modules and display the information through the display module of the display device.

Similar to the smartphone 10_1a, the tablet PC 10_1b, the laptop 10_1c, the TV 10_1d, and the desk monitor 10_1d may include a display module and an input module, and in an embodiment, may further include a communication module.

Referring to FIG. 25, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module configured to emit a display image and a reflector configured to reflect and provide the emitted display image to the user's eyes, thereby providing a virtual reality and/or augmented reality screen to the user.

The smartwatch 10_2c may include a biometric sensor as an input device and may provide biometric information recognized by the biometric sensor to the user through a display module.

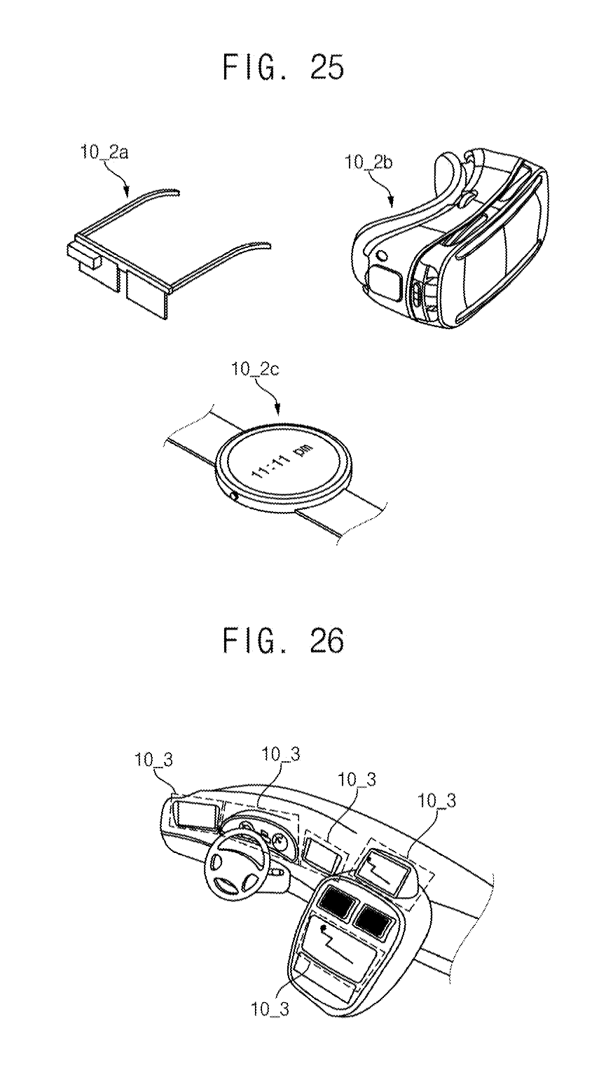

Referring to FIG. 26, an electronic device 10_3 including a display module may be applied to a vehicle. For example, the electronic device 10_3 may be applied to a dashboard, center fascia, etc. of a vehicle, and/or may be applied to a CID (Center Information Display) placed on a dashboard of a vehicle and/or a room mirror display replacing a side mirror.

Although not illustrated, electronic devices to which the display device according to one or more embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, the display module may be applied to electronic devices, such as smart windows or transparent display devices configured to display a background and a display image together. The type of electronic device according to the embodiment is not limited by the examples, and application to other various electronic devices that are not illustrated may also be possible.

The display device according to one or more embodiments may be applied to a display device included in, for example but not limited to, a computer, a notebook, a mobile phone, a smart phone, a smart pad, a PMP, a PDA, an MP3 player, or the like.

As described above, in a non-emitting period of a pixel circuit included in a display device, a high power voltage may be changed. In the non-emitting period, the high power voltage may be changed based on a determined grayscale of a display region. Accordingly, a flicker visibility of the display panel may be reduced. Accordingly, a display quality of a display panel may be improved.

At least one of the components, elements, modules or units (collectively “components” in this paragraph) represented by a block in the drawings and/or described in the specification, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

The foregoing is illustrative of the present disclosure and is not to be construed as limiting thereof. Although a few example embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display device comprising:
a display panel comprising a plurality of pixel circuits; and
a display panel driver configured to driver the display panel,
wherein the display panel comprises a first display region and a second display region,
wherein a pixel circuit of the plurality of pixel circuits comprises:
a writing transistor configured to apply a data voltage in response to a write gate signal;
a driving transistor configured to generate a driving current based on a high power voltage and the data voltage; and
a light emitting element comprising a first electrode configured to receive the driving current and a second electrode configured to receive a low power voltage lower than the high power voltage,
wherein a frame period in which the pixel circuit is driven comprises an emitting period in which the light emitting element emits a light and a non-emitting period in which the light emitting element does not emit a light,
wherein a first high power voltage applied to the first display region is different from a second high power voltage applied to the second display region, and
wherein a voltage level of at least one of the first high power voltage or the second high power voltage is changed in the non-emitting period.

2. The display device of claim 1, wherein the display panel driver comprises a gate driver configured to output the write gate signal,
wherein the gate driver is apart from the display panel in a first direction, and
wherein the second display region is adjacent to the first display region in a second direction different from the first direction.

3. The display device of claim 2, wherein after a voltage level of the first high power voltage is changed, a voltage level of the second high power voltage is changed.

4. The display device of claim 1, wherein the voltage level of the at least one of the first high power voltage or the second high power voltage is changed based on a grayscale of a current frame.

5. The display device of claim 1, wherein the first display region comprises a first pixel-row to an m-th (m being a positive integer) pixel row, and
wherein the first high power voltage is changed in the non-emitting period of a pixel-row of the first to m-th pixel-rows.

6. The display device of claim 5, wherein the first to m-th pixel-rows are sequential, and the first high power voltage is changed in the non-emitting period of the first pixel-row.

7. The display device of claim 6, wherein the first high power voltage is changed before a first time from the emitting period of the first pixel-row.

8. The display device of claim 7, wherein the first time is set based on a number of the first to m-th pixel-rows included in the first display region.

9. The display device of claim 7, wherein based on an increase in a grayscale displayed on the first display region, the first high power voltage is changed before a second time from the emitting period of the first pixel-row, and
wherein the second time is shorter than the first time.

10. The display device of claim 7, wherein based on a decrease in a grayscale displayed on the first display region, the first high power voltage is changed before a third time from the emitting period of the first pixel-row, and
wherein the third time is longer than the first time.

11. The display device of claim 1, wherein the display panel driver comprises a gate driver configured to output the write gate signal,
wherein the display panel further comprises a third display region,
wherein the gate driver is apart from the display panel in a first direction,
wherein the second display region is adjacent to the first display region in a second direction different from the first direction,
wherein the third display region is adjacent to the second display region in the second direction, and
wherein a third high power voltage is applied to the third display region, the third high power voltage being different from the first high power voltage and the second high power voltage.

12. The display device of claim 11, wherein after the first high power voltage and the second high power voltage are changed, the third high power voltage is changed.

13. The display device of claim 11, wherein a timing in which the first high power voltage is changed is different from a timing in which the third high power voltage is changed.

14. A display device comprising:
a display panel comprising a plurality of pixel circuits; and
a display panel driver configured to driver the display panel,
wherein the display panel comprises a first display region and a second display region,
wherein a pixel circuit of the plurality of pixel circuits comprises:
a writing transistor configured to apply a data voltage in response to a write gate signal;
a driving transistor configured to generate a driving current based on a high power voltage and the data voltage; and
a light emitting element comprising a first electrode configured to receive the driving current and a second electrode configured to receive a low power voltage lower than the high power voltage,
wherein a first high power voltage applied to the first display region is changed in a period in which the light emitting element in the first display region does not emit a light.

15. The display device of claim 14, wherein the display panel driver comprises a gate driver configured to output the write gate signal,
wherein the gate driver is apart from the display panel in a first direction,
wherein the second display region is adjacent to the first display region in a second direction different from the first direction, and
wherein a second high power voltage applied to the second display region is different from the first high power voltage.

16. The display device of claim 14, wherein the first display region comprises a first pixel-row to an m-th (m being a positive integer) pixel-row which are sequential, and
wherein the first high power voltage applied to a pixel-row of the first to m-th pixel rows is changed in a period in which light emitting elements of the pixel-row do not emit a light.

17. An electronic device comprising:
a display panel comprising a plurality of pixel circuits;
a processor configured to output an input image data and an input control signal; and
a display panel driver configured to drive the display panel based on the input image data and the input control signal,
wherein the display panel comprises a first display region and a second display region,
wherein a pixel circuit of the plurality of pixel circuits comprises:
a writing transistor configured to apply a data voltage in response to a write gate signal;
a driving transistor configured to generate a driving current based on a high power voltage and the data voltage; and
a light emitting element comprising a first electrode configured to receive the driving current and a second electrode configured to receive a low power voltage lower than the high power voltage,
wherein a frame period in which the pixel circuit is driven comprises an emitting period in which the light emitting element emits a light and a non-emitting period in which the light emitting element does not emit a light,
wherein a first high power voltage applied to the first display region is different from a second high power voltage applied to the second display region, and
wherein a voltage level of at least one of the first high power voltage or the second high power voltage is changed in the non-emitting period.

18. The electronic device of claim 17, wherein the display panel driver comprises a gate driver configured to output the write gate signal,
wherein the gate driver is apart from the display panel in a first direction, and
wherein the second display region is adjacent to the first display region in a second direction different from the first direction.

19. The electronic device of claim 17, wherein the first display region comprises a first pixel-row to an m-th pixel-row (m being a positive integer), and
wherein the first high power voltage is changed in the non-emitting period of a pixel-row of the first to m-th pixel-rows.

20. The electronic device of claim 19, wherein the first to m-th pixel-rows are sequential, and the first high power voltage is changed in the non-emitting period of the first pixel-row.
